(19) United States
(12) Patent Application Publication
(10) Pub. No.: US 2021/0034021 A1
(43) Pub. Date: Feb. 4, 2021

(54) METHOD FOR OPTIMIZED OPERATION OF A FAN OR A FAN ASSEMBLY

(71) Applicant: ZIEHL-ABEGG SE, Künzelsau (DE)

(72) Inventor: Bjoern WENGER, Schrozberg (DE)

(21) Appl. No.: 16/967,698

(22) PCT Filed: Feb. 4, 2019
(86) PCT No.: PCT/DE2019/200009

§ 371 Date: Aug. 5, 2020

(30) Foreign Application Priority Data
Feb. 5, 2018 (DE) 10 2018 201 709.3

(51) Int. Cl. G05B 13/02; G06F 30/27; G06N 20/00

(52) U.S. Cl. CPC G05B 13/027; G06F 2111/10; G06N 20/00; G06F 30/27

(57) ABSTRACT

In a method for optimizing the operation of a fan or a fan arrangement, using a digital replica of the fan or the fan arrangement and at least one operating parameter-specific algorithm, the data and findings obtained during operation are fed to a constant innovation and algorithm analysis with the goal of generating product innovations while at the same time generating improved “intelligent” algorithms.

This disclosure relates to a method for optimizing the operation of a fan or fan arrangement using a digital replica of the fan or the fan arrangement and at least one operating parameter-specific algorithm.

### 1. Digital Twin and Twin Algorithm

This is based on the fundamental concept of ensuring the highest possible efficiency and the best possible running performance at every duty point of the fan. Due to opposing operating parameters, this is difficult.

As is known from practical experience with fans, the ball bearing and the ball bearing grease are important parameters for the service life of a fan. The service life of the ball bearing and of the ball bearing grease is dependent largely on the operating temperature in or on the motor and on the mechanical forces acting on the ball bearing. Since neither temperature sensors nor force sensors can be positioned in the immediate vicinity of the bearing, neither the bearing temperature nor the bearing forces acting on the bearing can be measured. It is therefore necessary to either measure these parameters indirectly or determine them computationally.

DE 10 2010 002 294 A1 discloses a system and method for determining the state of the bearing of an electric machine. Actual sensor units ascertain a measured value, which is transmitted to a simulation unit. By use of the simulation unit, a result value is ascertained, which is either a bearing current value or a value that is dependent on the bearing current. The result value is transmitted to a further unit for further calculation. Due to the sensor technology that is required, the known system/method is complex and is difficult to use in fans that lack sufficient installation space.

The digital twin and the twin algorithm are based on the creation of a digital replica of an actual fan, specifically by replicating the properties thereof using mathematical calculation models and optionally by incorporating known data, if applicable actual measurement data. The actual measurement data may be current measurement data from the running operation of each individual motor (and optionally from its history). Additionally, at least one operating parameter-specific algorithm is created, factoring in known circumstances, characteristic curves, etc., and is used for further calculations.

The digital replica is used to ascertain or calculate component states of the fan by use of virtual sensors. These component states are fed to the operation-specific or operating parameter-specific or product-specific algorithm, which determines or calculates specific operating parameters of the fan from the component states and, derived therefrom, optionally provides predictions relating to the operation of the fan, for example predictions regarding the service life of the fan. What is advantageous is that the combined use of ascertained component states and actual measurement data is possible.

Two different software components are used for this purpose, specifically a first software component relating to the digital twin and a second software component relating to the operating parameter-specific algorithm, which can be referred to as an “intelligent” algorithm.

The digital twin is a digital replica of an actual, individual object, in the case of the teaching of the disclosure a fan or a fan system. The digital twin replicates the properties of the fan by use of a calculation model and, if necessary, using known data about the fan. The task of the digital twin is to calculate component states of the components of the fan as a function of the respective operating state using virtual sensors. The component states determined on the basis of such a calculation are transferred to the operating parameter-specific algorithm, which uses the operating data of the digital twin to determine/calculate operating parameters or operating states of the fan, for example the bearing service life and/or the bearing grease service life. Based on the result, a situation-specific adaptive control is possible. Operating parameters and operating states are equally relevant insofar as they are calculable variables.

The above-described combination of digital twin and operating parameter-specific algorithm can be implemented as a digital twin algorithm on a microprocessor assigned to the motor of the fan and can thus be assigned to the fan as a fixed component.

The digital twin algorithm is the combination of a digital twin that describes the fan and a type of intelligent algorithm that is designed for specific operating parameters.

With a correspondingly designed fan, predictive maintenance can be carried out with the goal of avoiding a fan failure, for example due to a defective bearing or defective bearing grease. The aim is a situation-specific adjustment of system parameters to allow nearly the maximum possible service life of the fan to be realized.

Using a digital replica of the fan and running parameter-specific algorithms, the goal of predictive maintenance is to utilize the service life of the components of the fan as fully as possible and at the same time to avoid any failure of the fan. The service life of the fan is calculated on the basis of calculated component states and operating parameters resulting therefrom.

The digital twin uses physical and/or mathematical and/or statistical and/or empirical and/or combined models to calculate thermal and mechanical component states. Mathematical models along with physical and non-physical models are used in any case. The operating parameter-specific algorithm (intelligent algorithm) requires the component states ascertained from the digital twin in order to determine any operating parameters, including predicting failure of the fan, for example. Since the service life of a fan depends primarily on the ball bearings and the ball bearing grease, the operating parameter calculation that is focused on the ball bearing grease and the ball bearing plays a very significant role.

As is known from practical experience, the service life of bearing grease depends largely on the operating temperature. The higher the operating temperature over the entire service life, the faster the bearing grease will be used up. Thus, it is important to ascertain the bearing temperature in order to determine the bearing grease service life.

To ascertain the bearing temperature, a temperature sensor would have to be positioned in the immediate vicinity of the bearing. Due to the geometric and functional circumstances of the fan/motor, this is not possible. In the manner according to the disclosure, component states such as the bearing temperature are therefore calculated using the digital twin along with an operating parameter-specific algorithm.

This calculation is based on a mathematical model, which is in turn based on a reduced coupled thermomagnetic calculation model. The combination of digital twin and operating parameter-specific algorithm calculates heat sources, heat sinks, and the thermal state of the overall system relating to the motor of the fan. Thus, the bearing grease temperature can be determined, as a function of the operating state of the fan/motor, via the virtual sensors of the digital twin and can be fed as an operating state into the operating parameter-specific algorithm.

Both the digital twin, including its virtual sensors, and the operating parameter-specific algorithm can be implemented in machine code (C code) on the existing microprocessor, which implies that a certain machine intelligence is incorporated into the fan.

The above explanations describe a method for ascertaining operating states of a fan using a digital replica (digital twin) of the fan along with at least one operating parameter-specific algorithm. This forms the basis for the subsequent method stages of calculating operating states, which are determined using virtual sensors based on a digital twin algorithm, wherein a workflow for implementing the digital twin algorithm with respect to the fan is defined. As such, this serves to reduce the number of actual sensors used for determining operating states.

### 2. Intelligent Fan

Through a method for optimizing the efficiency and/or the running performance of a fan, a quasi “intelligent” fan is created, wherein proceeding from component-specific or function-specific numerical detailed models and based on at least one algorithm, a model reduction and thus a data reduction (data refinement) to component-specific or function-specific behavior models is performed, wherein the reduced data of the behavior models are coupled or combined in a system simulation to form a system behavior model with input and output variables, and wherein the input variables and associated output variables of the fan from the system behavior model are made available to an optimizer for selection in order to achieve an optimized control of the system as a function of underlying conditions.

This refers to the digital twin algorithm in the context of an “intelligent” fan as a further refinement of the twin algorithm described in section 1.

The further development of the digital twin algorithm is understood as an independent, situation-specific adjustment of the system parameters of the fan or the fan system in order to ensure the best possible efficiency and the best possible running performance at every duty point.

First, detailed numerical models are created, for example relating to a thermal model, a magnetic circuit model, or a model relating to the blade position and the flow or flow conditions. The detailed model can likewise be a digital twin in accordance with the introductory part of the description with respect to a fan environment, for example a data center provided for an entire system. The detailed model can also relate to the digital twin of a fan arrangement. Other detailed models are also conceivable.

In the next stage, the detailed models are reduced as part of a model reduction, specifically to what are known as behavior models. This is accompanied by a considerable reduction in the associated data.

In the system simulation, the behavior models with reduced data volumes are then linked, resulting in a behavior study with a combined behavior model.

The entire system is simulated in the system space with a homogeneously distributed combination of input variables. The result is a table containing the input combinations and associated system output variables. The table reflects a system behavior model, specifically with input variables and associated output variables of the fan. Based on these variables, optimization is possible.

While the system is operating, based on the ambient conditions, an optimizer searches the behavior model table for the best possible system output variables, such as the system efficiency, (e.g., in real time). As soon as the best possible system output variable is found, the associated input variables can be read from the table. With these input variables, the system is controlled in an optimized manner (e.g., in real time).

In light of the above description, it is advantageous for the optimizer to select the optimal system efficiency from the system behavior table and to supply the necessary input variables to the control system. In this way, constant optimization is possible.

### 3. Optimization According to the Disclosure

Based on the digital twin together with the twin algorithm and based on an optimization of the efficiency and/or the running performance of a fan using an “intelligent” fan, the object of the present disclosure is to generate a constant improvement of the digital twin algorithm on the one hand and, on the other hand, to generate improved products (fans) through product innovation, specifically using calculated operating states.

The aforementioned object is achieved by the features of claim 1, specifically by a method for optimizing the operation of a fan or a fan arrangement using a digital replica of the fan or the fan arrangement and at least one operating parameter-specific algorithm, wherein the data and findings obtained during operation are fed to a constant innovation and algorithm analysis with the goal of generating both product innovations and improved “intelligent” algorithms.

The basis for the method according to the disclosure is the use of a digital twin and the twin algorithm used therein, in accordance with the introductory description in sections 1 and 2.

Through innovation analysis on the one hand and algorithm analysis on the other hand, the digital twin algorithm is constantly improved and new product innovations are generated.

The basis for the method according to the disclosure is the digital twin algorithm, which calculates operating states of the fan during operation, i.e. on site on the customer's premises. These operating states are sent to the cloud for analysis followed by further processing. The analysis advantageously utilizes a special tool, specifically a program unit for machine learning in the cloud. “Machine learning” is understood as the artificial generation of knowledge from experience.

An artificial system of this type learns from examples of the calculated operating states according to the digital twin algorithm and is able to generalize these once the actual learning phase has ended. Such a system recognizes patterns and regularities in the learning data based on the calculated operating states.

In light of the above, product innovations and improvements to algorithms can be made.

It is further advantageous that the calculation and recording of component states is used for obtaining new knowledge, for example, for the design of new products. A constant increase in digital know-how occurs.

The innovation analysis also makes it possible to determine what the customer actually requires with respect to the fan, on the basis of a specific requirements profile. Thus, new innovations are created through fan products that are individually tailored to the customer.

The innovation analysis provides a “feedback to design” through the analysis of smart data, as are obtained through model reduction in accordance with section 2 of the introductory part of the description.

Existing or improved algorithms can be used to calculate the service life or to optimize the performance of the fan and can be improved over the course of the analysis. The improved algorithms make the fan “intelligent” and enable the best possible prediction for maintenance. This is advantageous.

Ultimately, the improved algorithms and new product innovations are used in the development of new fan products and, on top of that, lead to a constant improvement of the digital twin algorithms.

There are various options for the advantageous configuration and refinement of the teaching of the present disclosure. Reference is made in this regard to the claims subordinate to claim 1 and to the following description of an exemplary embodiment of the disclosure, with reference to the set of drawings. In conjunction with the description of the exemplary embodiment of the disclosure, in which reference is made to the set of drawings, configurations and refinements of the teaching are generally also explained. In the set of drawings,

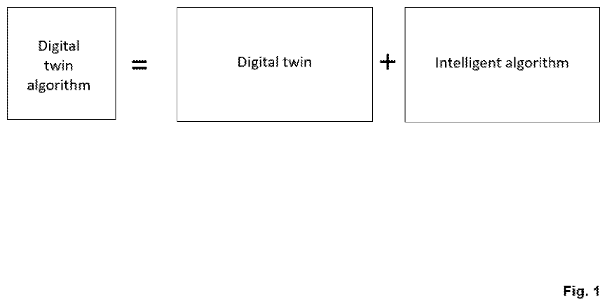

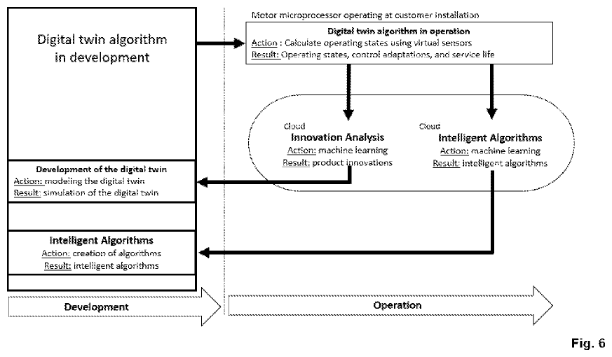

FIGS. 1 to 16 show method stages for implementing the teaching according to the disclosure with specific characteristics; the teaching according to the disclosure is explained by way of example in reference to FIG. 6.

FIGS. 1 to 5 serve to clarify the teaching of the disclosure and relate to the digital twin and the digital twin algorithm as the basis for the intelligent fan.

Specifically, FIG. 1 shows the combination of the digital twin with at least one operating parameter-specific algorithm, which is referred to in the following as the digital twin algorithm. This can be explained using the example of the service life of the bearing grease and/or of the bearing.

As stated above, the service life of bearing grease and bearings is dependent on the operating temperature and the speed of the motor. Since a temperature sensor cannot be positioned in the immediate vicinity of the bearing, the bearing temperature must be calculated using a model, according to the disclosure using the digital twin algorithm, which results from a combination of the digital twin and an operating parameter-specific algorithm (intelligent algorithm).

The digital twin is nothing more than a mathematical model, which is based on a reduced coupled thermomagnetic and mechanical computational model. The digital twin calculates the thermal and mechanical state of the entire system as it relates to the motor. By use of the virtual sensors belonging to the digital twin, the digital twin can ascertain the bearing grease temperature based on the operating state of the motor.

The intelligent algorithm requires the component states for further processing of the data, in order to predict fan failure, for example. Based on failure characteristic curves, the failure of the motor can be calculated or at least estimated. All of the software relating to the digital twin algorithm is implemented in machine code (C code) on the motor microprocessor, so that no additional electronic system is required.

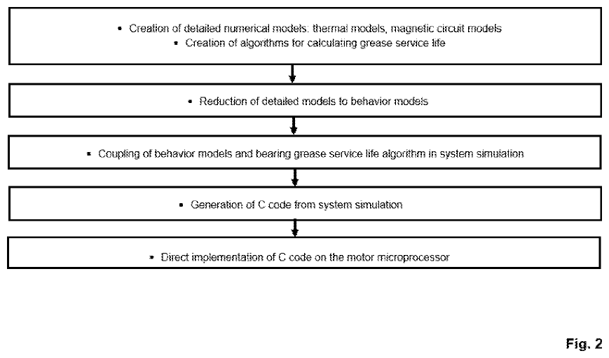

FIG. 2 shows the process sequence in the calculation of the service life of bearing grease in the bearing of a fan motor. For creating the digital replica of the actual fan, numerical detailed models, specifically thermal models, magnetic circuit models, etc., are required. In addition, algorithms for calculating grease service life are created.

The detailed models are then reduced to behavior models so that the volume of data is manageable.

The behavior models and the algorithm used to calculate the bearing grease service life are then linked in a system simulation, specifically as part of a combination of the digital twin with the operating parameter-specific algorithm, which in the present case is used to calculate the bearing grease service life. The C code is generated from the system simulation, and the C code is implemented directly on the motor microprocessor.

As stated above, the detailed model must be reduced to a behavior model in order to decrease the computing time. This measure allows the digital twin algorithm to be implemented on the microprocessor of the motor. For reduction of the thermal model, various methods can be used, for example the Krylov method. In said method, the data of the detailed model are reduced by diminishing the model order.

The magnetic detailed model can be reduced using an algorithm or using a table. Precalculated results are defined in the table for certain constellations, so that complex calculations can be replaced by a quick value search. Using the correspondingly reduced models, the bearing grease temperature and the bearing temperature can be calculated. The calculated values use the operating parameter-specific algorithm, in this case the algorithm for calculating the bearing grease service life, to calculate the service life of the bearing grease and of the bearing.

It is also possible to weight, (e.g., exponentially), the consumed service life of the bearing/bearing grease based on the operating temperature.

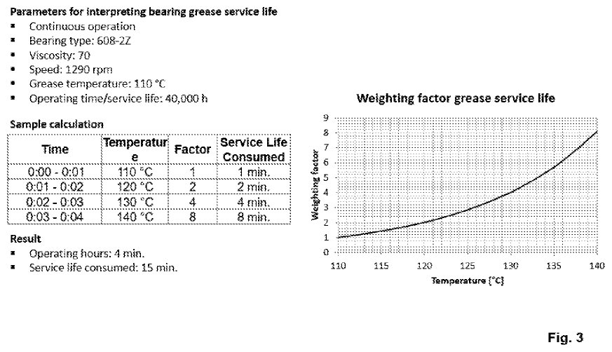

FIG. 3 shows the course of such a weighting factor as a function of temperature, with parameters such as continuous operation, bearing type, viscosity, speed, grease temperature, and operating time/service life being used, by way of example, for calculating the bearing grease service life. With an operating period of four minutes, the sample calculation gives a service life consumption of 15 minutes.

The reduced models according to the digital twin and the operating parameter-specific algorithm relating to the bearing grease service life are integrated into a system simulation and linked to one another. The system simulation can be created in the MATLAB program, for example. Using the MATLAB code generator, the system simulation can be translated into C code and implemented on the motor microprocessor.

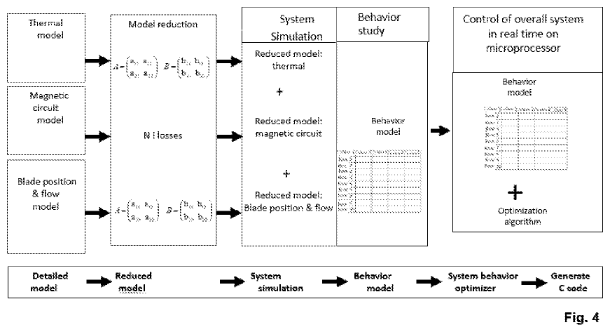

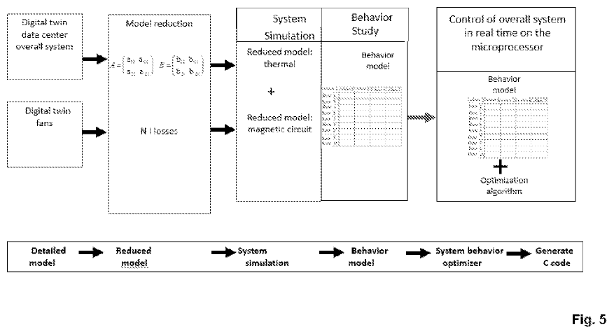

FIGS. 4 and 5 show the individual stages of the method involved in creating the “intelligent” fan, with FIG. 4 referring to the setting of the blade angle and FIG. 5 referring to the load distribution of fans in a data center. The respective method stages, from the creation or provision of a detailed model to a reduced model, a system simulation, and a behavior model, are identical in both cases. Using the behavior model as a basis, the optimizer selects the optimal system efficiency from the system behavior table and forwards the corresponding input variables to the controller, with control taking place in real time. The procedure along with data are generated in C code so that the optimization can run on a standard processor.

According to the diagram of FIG. 4, the blade position angle of the fan blades is to be controlled such that optimal system efficiency is achieved depending on the duty point. Based on a suitable algorithm, a reduced model is derived from the detailed model, and from this reduced model, a behavior study or a resulting behavior model is developed as part of a system simulation, based on multiple detailed models. The optimizer selects the optimal system efficiency from the system behavior table and forwards the corresponding input variables with which the optimization can be achieved to the control mechanism. The entire system is controlled in real time on a microprocessor, specifically based upon the behavior model and the algorithm used for optimization. The data and the algorithm via the programming are in C code.

The diagram of FIG. 5 refers to the load distribution in an arrangement of multiple fans, in the selected exemplary embodiment the load distribution of fans of a data center. The flow velocity and the load distribution of individual fans necessitated by said velocity are to be controlled such that an optimal system efficiency is produced depending on the prevailing temperature in the data center. Here again, the optimizer selects the optimal system efficiency from the system behavior table and forwards the corresponding input variables to the control mechanism, so that the entire system can be controlled in real time on a microprocessor. And once again, the data of the behavior model are fed into the algorithm used for optimization, with the program running in C code on standard processors.

Based on the data reduction described above, the method enables a compact C code to be generated which can be run on standard microprocessors. On the microprocessor, a type of data refinement (Big Data→Smart Data) takes place, which is the result of calculation. Only the compressed, refined data are processed further or, for example, sent to a cloud. Naturally, this significantly reduces the streaming volume of the connection to the cloud.

The operating parameters ascertained with the digital twin and the operating parameter-specific algorithm can further be used for predictive maintenance and for maintenance of a fan, as well as for optimizing the design and operation of a fan, with the digital twin algorithm being refined to adapt the system parameters specifically to the individual situation, namely to guarantee the best possible efficiency and the best possible running performance at every duty point.

FIG. 6 schematically outlines the sequence of stages in the method of the disclosure, with the digital twin algorithm running on the fan motor microprocessor while the fan is operating. Operating states are calculated using virtual sensors. Based on the operating states, adaptive control is possible and the fan service life can be calculated.

The data are transferred from the motor microprocessor to the cloud for innovation analysis and for algorithm analysis.

As part of the innovation analysis, machine learning takes place, resulting in constant product innovations.

Machine learning also takes place as part of algorithm analysis, resulting in increasingly intelligent algorithms.

The results of both analyses—innovation analysis and algorithm analysis—are fed back to improve the digital twin and the digital twin algorithm, with the goal of “intelligent” algorithms and to create “intelligent” fans.

For the teaching according to the disclosure, as part of a specific characteristic in accordance with the features of claim 5, it is especially important for patterns and regularities to be recognized. In addition to the above, the following can be stated:

“Artificial intelligence” is the generic term used to describe all fields of research dealing with the performance by machines of tasks usually requiring human intelligence. One sub-field of artificial intelligence is “machine learning”, which gives machines the ability to generate “knowledge” from experience, in other words to learn. “Deep learning” using artificial neural networks is an efficient method of perpetual machine learning based on the statistical analysis of large volumes of data and is therefore the most important future-oriented technology within artificial intelligence.

“Deep learning” is one learning method within the field of machine learning. The use of neural networks enables the machine itself to recognize structures, to evaluate this recognition, and to independently improve or optimize itself in multiple forward and backward runs.

For this purpose, the artificial neural networks are divided into multiple layers. These act as a weighted filter that works from coarse to fine, thereby increasing the probability of recognizing a pattern and outputting a correct result. This is modeled on the human brain, which works in a similar way.

Artificial neural networks can be represented as matrices. This offers the advantage of enabling the necessary calculations to be performed very easily. Calculation on a conventional microprocessor, and thus also on a fan microprocessor, is possible. This enables the intelligent fan without the need for an internet connection.

Artificial neural networks can be used to adapt the digital twin algorithm to a wide range of products of a manufacturer and to different customer applications in a company. Artificial neural networks can also be used to predict fan failure on the basis of error patterns. Multiple related factors, such as increased current and increased electronics temperature, are used for this purpose.

It is important for the development of modern fans to be based on a digital twin of the fan and the use of a digital twin algorithm. From the operation of the fan, operating states are determined, and adaptive control and an influencing of the service life take place. The innovation analysis and the algorithm analysis are fed back to the digital twin algorithm and provide for an improvement toward an “intelligent” execution of the algorithm, with the further goal of creating an “intelligent” fan.

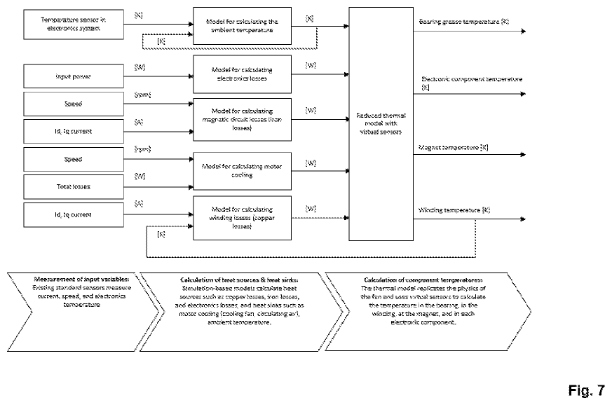

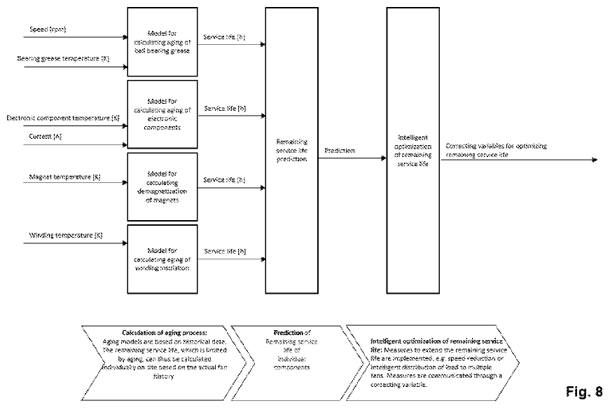

The diagrams in FIGS. 7 and 8 provide a more detailed explanation of the claimed teaching.

Advantageous is the use of a digital replica, specifically a digital twin of the fan. The digital twin is produced through data processing. Specifically, it is produced from a combination of known input variables or sensor measured values with calculated values and calculations/models. Based on the digital twin, component temperatures, currents, losses, etc. are ascertained at certain predetermined points on the fan. Based on the digital twin, actual values, such as specific component temperatures, are determined virtually, specifically when there is no economically/structurally viable option for measurement by use of sensors at the respective specific location on the fan.

Further important to the claimed teaching is the operating parameter-specific algorithm. Based on the results or the data provided by the digital twin, for example the bearing temperature, parameters such as the probability of failure or the consumed service life of the fan or the fan bearing are determined. These parameters are dependent on the current operating parameters of the fan and the history thereof, i.e. the duty points and environments in which the fan is being/has been operated.

FIGS. 7 and 8 illustrate, using a specific example, the method according to the disclosure for determining operating states of a fan using a digital replica of the fan, taking the above explanations into account.

In the left-hand column of FIG. 7, measured or calculated input variables including the units assigned to the arrows are listed. These input variables are measured using existing standard sensors or are known.

From these input variables, heat sources and heat sinks are calculated. These are based on simulation-based models that factor in heat sources such as copper losses, iron losses, and electronics losses, and heat sinks such as motor cooling (cooling fan, air flow, and ambient temperature). The result is input variables for a reduced thermal model with virtual sensors. All of this corresponds to the digital twin as a thermal model.

Using the reduced thermal model with virtual sensors, component temperatures are calculated. The thermal model replicates the physics of the fan and uses virtual sensors to calculate the temperature in the bearing, in the winding, at the magnet, and in the various electronic components, as needed.

Building on FIG. 7, FIG. 8 clearly shows that output variables from the reduced thermal model, optionally with additional parameters, are used as input variables for calculating the aging process. Underlying aging models are based on historical data and can be stored as characteristic curves. The remaining service life, which is limited by aging, can thus be calculated or corrected individually on site based on the actual fan history and the current operating state.

The respective models for calculating aging result in a calculated service life in days or hours, which on its own can serve merely as information. The relevant information can then be used for further forecasting, specifically for predicting the remaining service life of the individual components or of the entire fan. This prediction can then be used for intelligent optimization of the remaining service life. Measures to extend the remaining service life can be implemented, for example a reduction in the speed or an intelligent distribution of the load to multiple fans. These measures can be communicated by use of a correcting variable.

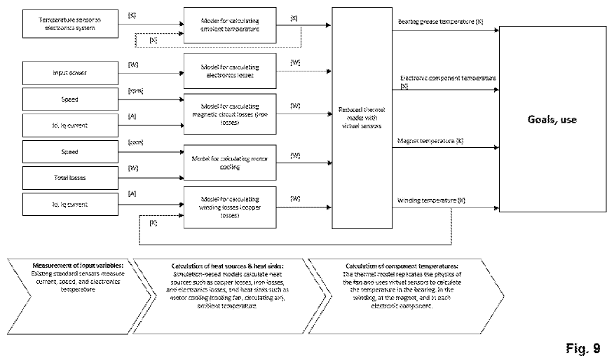

FIG. 9 again shows the digital twin up to the reduced thermal model with virtual sensors, whereby the fan and the motor are described. As stated above, the thermal model replicates the physics of the fan and uses virtual sensors to calculate different temperatures that are applied for different purposes/goals/uses, for example:
for monitoring: ascertaining operating parameters by use of virtual sensors and using these parameters for monitoring. These may be: warning messages, status LED's, comments in a readable error code, images in the cloud or application, display in user interfaces.
for predictive maintenance: method for determining the aging of a fan consisting of numerous subsystems, such as ball bearings, windings, electronic components, and magnets, and for predicting the remaining service life. Use, for example, for planning maintenance intervals, for achieving the longest possible service life prior to the maintenance interval (i.e. no premature servicing), automatic scheduling of maintenance, reporting of servicing needs, automatic ordering of spare parts.
for optimization: method for ascertaining operating states relating to product performance, i.e. efficiency, component temperatures, speed, output, volumetric flow rate, volume, vibrations, etc.
for creating an intelligent fan: response to certain operating states to improve behavior or to achieve certain goals.
   Changing the duty point/changing the control parameters for optimal efficiency.
   Changing the duty point to achieve the longest possible service life.
   Reducing the speed if the probability of failure is very high:
   Changing the duty point with a day-night rhythm for the quietest possible night-time use.
   Issuing a correcting variable for accessory systems or customer devices, e.g. temperature output for use in controlling a heat pump, or for additional cooling.
   Targeted avoidance of critical system states (e.g. resonances, excessive temperatures, etc.).

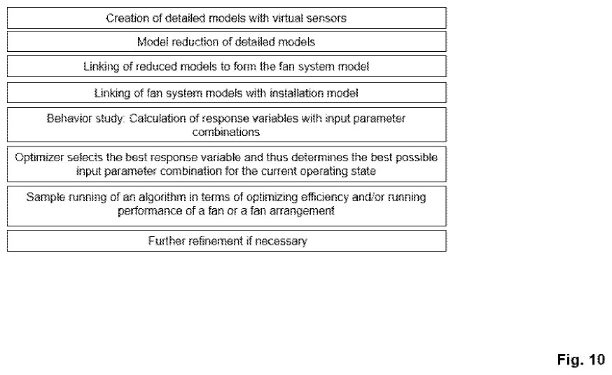

For a clearer understanding of the teaching of the disclosure, the order of the method stages and the contents thereof are important. The order of the respective method stages can be derived from the development workflow of the underlying algorithm. This is shown in FIG. 10, in which in a final stage the method can be further developed.

For creating a detailed model, the following is generally relevant:

A model is a replica or an approximation of reality, which by definition is a simulation. A model is always limited to a segment that is of interest for the intended replica. Moreover, a model is fundamentally incomplete, since either it is reduced for easier use in terms of its required input variables, or individual physical behavior elements are unknown at the time the model is created. Depending on the subsequent use and the objectives, different types of modeling may be required, i.e. different areas of consideration, different required accuracies of the results or the speed of the calculation, for example. There are many types of models; however, in technical fields, most models are connected with a mathematical representation, for example with algebraic equations or inequations, systems of ordinary or partial differential equations, state space representations, tables, or graphs.

Virtual product development using FE simulation (Finite Element Simulation) is an integral part of today's product development processes. Traditionally, a physical domain (e.g. stability or thermals or magnetic circuit) is replicated in a very large (100 gigabyte range) and computation-intensive model, and the results are determined at millions of points (nodes) in the model. This is one variant of detailed models. The process of creating these detailed models can be outlined roughly as follows:
1. Importing a 3-D geometry, for example from a CAD system,
2. Assigning boundary conditions, i.e. fixed constraints, material definitions, contact conditions (glue joints, sliding connections, thermal insulation),
3. Networking (separating the geometry into millions of small, linked elements),
4. Applying the loads, i.e. forces, heat sources/heat sinks, magnetic fields,
5. Automatically solving the resulting differential equations for each individual element and merging these into one overall result for the entire model,
6. Evaluating the results.

Detailed models that contain virtual sensors with respect to fans/entire systems that include fans are created as follows:

Detailed models are created with the goal of replicating the physics of the fan and/or of the system as a whole. So-called virtual sensors are defined calculation points in the detailed models. These virtual sensors calculate component states, such as the winding temperature in the thermal detailed model of the fan. Detailed models are simulation models that are complex in terms of computing time, processing power required, and memory requirements. Such detailed models, for example thermal models, magnetic circuit models, electronics models, control models, force models, or vibration models, are used for calculating non-linear operating states. The physical effects of the system include interactions between the domains, and therefore, the individual models must be regarded as coupled within the system as a whole. Calculations using detailed models in the entire system are not practicable in terms of computing time, since interactions cannot be evaluated in real time. A model reduction is therefore necessary.

The generation of reduced models can be carried out as follows:

A model reduction describes an existing model very generally, to reduce additional information in order to optimize the model in terms of memory requirements or computing speed, for example. There are many variants of model reduction depending on the specific application, for example:
Approximating simple mathematical functions, such as polynomial functions, and storing only the coefficients.
Storing tables for different input variables and then either using these discrete values or interpolating between the values.
Simulating statistical models that provide predictions from previous values.
Graphs/logic gates, for example: if T>200° C., then the fan is defective.

### Generation of Reduced Models—Example a)

The basis for the reduced model is an FE model of the thermals, which maps the temperatures at every point on the model as a function of the heat input and heat output. In the following example, the model reduction is simplified to only one heat input and one heat output, only one temperature to be determined at point A, and only the values “high” and “low”. For this purpose, a parameter study is carried out, from which this “look-up table” is created:

Temperature at Point A

| | Heat Input = | Heat Input = |
|---|---|---|
| | Low = 1 W | High = 11 W |
| Heat output = low = 1 W | 40° C. | 80° C. |
| Heat output = high = 5 W | 20° C. | 60° C. |

There are then several options for using the results.
Using the table directly and discretely. Example: If a temperature at point A is to be predicted for a heat input of 4 W and a heat output of 1 W, the value of 40° C. is assumed directly.
Using the table with linear interpolation between the values. Example: If a temperature at point A is to be predicted for a heat input of 5W and a heat output of 1 W, the value of 60° C. is determined via linear interpolation.
Using the table to determine a temperature prediction function by use of regression. Examples of target functions include polynomial functions, linear functions, exponential functions, statistical functions, differential equations, etc. Then using this function to determine the temperature.

### Generation of Reduced Models—Example b)

The basis for the reduced model is an FE model of the thermals, which maps the temperatures at every point on the model as a function of the heat input and heat output. Compact state space models can then be simulated using mathematical assumptions, calculations, and transformations (e.g. LTI system or Krylov subspace method). Said models consist of two differential or integral equations and four matrices that describe the entire system (for example, 200×200 matrices filled with scalar numerical values). However, these no longer plot the temperature at millions of nodes, but only at a few selected points. Moreover, approximation leads to a deviation of the results, dependent upon the size of the state space model. Generally, the larger the model and its matrices, the smaller the deviation.

State space models are available on a standard basis as procedures, modules, or objects in many computer algebra programs such as MATLAB, or in programming languages, which implies that such models can be calculated by simply importing the matrices. Input variables in this case are, for example, heat output that enters the system and heat sinks resulting from convection; output variables are, for example, certain component temperatures (e.g. three different component temperatures).

### Generation of Reduced Models—Example c)

In this example, experimental results form the basis for the model reduction. In this case, as in example a), a table of measurement results would be created, and the process would then continue in an equivalent manner (discrete use, linear interpolation, or regression using mathematical functions).

A coupling of physical domains or of different models can further be of use.

Traditionally, in virtual product development domains are considered individually, since considering them together is highly computationally intensive and memory intensive and is not really practicable. Model reduction makes it possible to couple the models from different domains. For example, coupling a detailed magnetic circuit model, the computing time of which totals several days to weeks on a powerful computing cluster, with a thermal model offers no advantage. In many cases, this is necessary for replicating actual behavior with maximum accuracy.

### COUPLING OF PHYSICAL DOMAINS OR DIFFERENT MODELS—EXAMPLES

Winding resistance is approximately linearly dependent on the temperature of the copper. The power loss in the winding changes approximately linearly as a function of the winding resistance. As a function of the power loss, the thermal behavior, for example, the winding and bearing temperature, changes in a highly non-linear manner, which in turn affects the winding resistance. Thus, depending on the requirements for the results of the model, coupling is necessary in this case.
The required torque and the speed of a fan are heavily dependent on the system resistance and, for example, the pressure difference and temperature of the conveyed medium. The behavior of the magnetic circuit, i.e. currents through the winding, magnetic field, speed, etc., changes as a function of the load torque. Power consumption, losses, and achievable speed then also change as a function of this behavior. Here again, in the case of a customer application, it may be conceivable to couple the fan behavior to the installation situation, dependent upon the individual case.

### Details of a Technical Implementation—Example a)

Creation of a thermal FE model of a fan computationally intensive and memory intensive FE model with 1,000,000 elements in addition to the polynomial function. Heat sources and heat sinks are mapped as polynomial functions dependent upon input current and speed.
Creation of a reduced thermal model by statistical methods, which maps the electronic component temperature as a function of input current and speed. Polynomial function that describes the temperature as a function of input current and speed=virtual temperature sensor.
Characteristic curve from data sheet showing the service life of the electronic component as a function of its temperature operating parameter-specific algorithm that calculates the probability of failure from a virtual temperature sensor.
Use for predictive maintenance, for monitoring, or for optimizing the duty point intelligent algorithm.

### Details of a Technical Implementation—Example b)

Detection of current indicator and motor speed by integrated electronics/control. From this, the electromagnetic operating point is derived.
Based on this operating point, motor losses and power electronics losses are obtained from look-up tables or using polynomial functions.
A thermal model processes the loss values and determines temperatures of important system components such as ball bearings or semiconductor components.
At the same time, component vibrations are recorded by an actual sensor. The local vibrations are projected virtually onto the system as a whole using behavior models, thereby allowing the bearing load to be estimated on the basis of vibrations, for example.
Using operating parameter-specific algorithms, determined temperatures and vibration values are converted to an estimate of the component and fan service life.
Further measures such as predictive maintenance are thereby enabled.
At the same time, if the losses are known, the operating point and system efficiency can be optimized through control engineering adjustments, such as varying the lead angle.

The above specifications relating to model reduction of the detailed models apply to a practical application for fans and/or fan systems, in which case an order reduction may be performed using the Krylov subspace method. The goal is to minimize the computing time, the required computing power, and the memory requirement, so that a calculation in real time is possible. The virtual sensors are retained and provide output variables.

According to FIG. 10, in the next stage the reduced models are linked to form the fan system model. In specific terms, the reduced models such as the thermal model, the magnetic circuit model, the software model, the electronics model, etc. are linked to form a fan system model. The fan system model replicates the physics of the individual fan or of a fan group or a fan system and calculates the efficiency, the running performance, and any interactions between the individual models as a function of the ambient conditions and operating states.

In the next stage, the fan system models are linked to the installation model, creating an overall system model. The overall system model consists of multiple fans and an installation, for example comprising a compressor and/or condenser. The installation model can be created using the same workflow as the fan system model. The fan system models and the installation model can then be linked to form an overall system model.

The next stage includes a behavior study, specifically the calculation of response variables with combinations of input parameters.

The goal of the study is to determine the behavior of the overall system model and to use this knowledge to control the system in real time.

Based on the overall system behavior, effects and influences of model input variables are transferred or mapped onto the model response variables in the design space.

The design space is a multi-dimensional space that is spanned by the possible input variables. The number of input variables corresponds to the dimension of the design space. With ten input variables, this implies ten dimensions.

The model input variables are varied within defined limits. This creates combinations of parameters that evenly cover and thereby describe the multidimensional space. The model response variables such as efficiency and running performance are calculated using the parameter combinations. The behavior study provides a design space that is filled with response variables as a function of the input variables. This space replicates the behavior of the system as a whole.

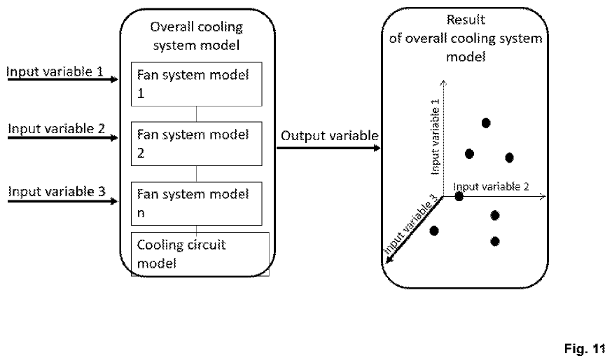

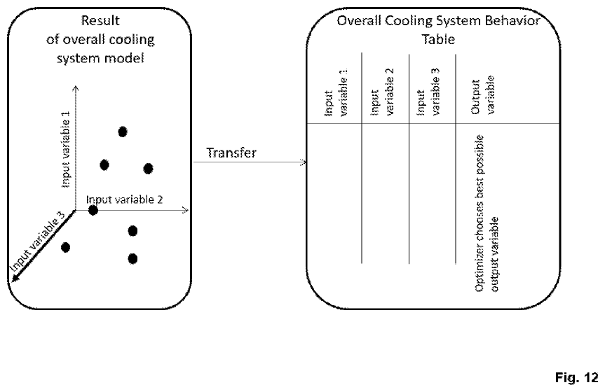

FIG. 11 shows how different input variables flow into fan system models and cooling circuit models, resulting in the overall cooling system model. A corresponding output variable is understood as the result of the overall cooling system model. The resulting knowledge can be converted to a behavior table, as shown in FIG. 12. If the overall system behavior is known, the input variables can be adjusted in order to obtain the best possible response variable.

The adjustment or the selection of the response variable and the associated input variable combination from the behavior table is carried out by an optimizer, specifically according to the further method stage shown in FIG. 10, according to which the optimizer selects the best response variable and thus selects the best possible input parameter combination for the current operating state.

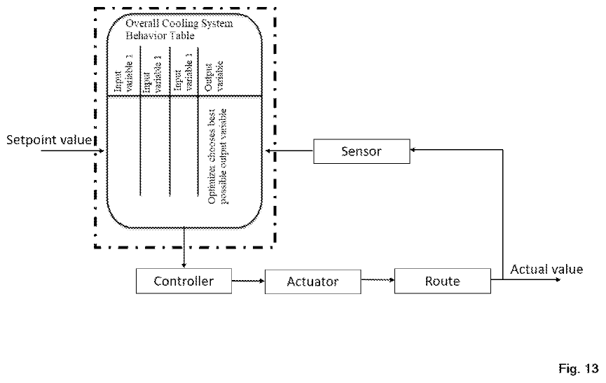

According to the diagram of FIG. 13, the optimizer selects the best response variable and determines the best possible input parameter combination for the current operating state. In other words, the optimizer chooses the best possible model response based on the ambient condition/operating state. The associated parameter combinations of the input variables are adjusted. Control of the system can thereby be optimized. The overall cooling system behavior table can run on any processor, for example, on a microprocessor already provided as part of the fan. Control is thereby enabled.

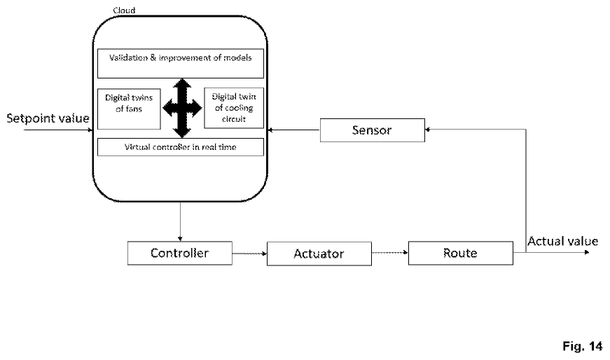

FIG. 14 concerns a possible refinement, according to which the overall cooling system behavior table as shown in FIG. 13 is expanded by adding a system simulation of the cooling circuit in a cloud. The system includes digital twins of the fan, digital twins of the cooling circuit, a validation unit, and a virtual controller/optimizer.

The digital twins of the fan and of the cooling circuit physically replicate the system. The knowledge from the overall cooling system behavior table as shown in FIG. 13 is available to the virtual controller. Moreover, through machine learning the virtual controller can learn more about this, for example with respect to specific customer applications. The validation unit improves the digital twins by comparing setpoint value with actual value. Thus, the system is capable of simulating specific customer patterns and improving from the resulting knowledge.

According to the combination of features recited in the claims, innovation analysis is provided. The goal of innovation analysis is to improve efficiency and running performance and to reduce material costs through knowledge gained from the customer application. Digital images of actual customer operations are collected. Through pattern recognition, optionally using AI (AI=artificial intelligence, machine learning), the characteristic properties of the customer's operations are filtered out and recognized. Based on the characteristic properties from the customer's operations, a customer model is created. The model is analyzed for weaknesses using artificial intelligence.

One example of such a weakness would be operation of the fan in an area where cooling is not optimal. The efficiency has declined as compared with catalog measurements. Once such weaknesses have been identified, the goal of optimization is to increase efficiency at the customer's operating point. The optimizer uses the detailed model of the fan and the customer pattern model for optimization. The result of the optimization may be a winding adjustment, for example, and/or a geometry adjustment to improve the cooling of the fan.

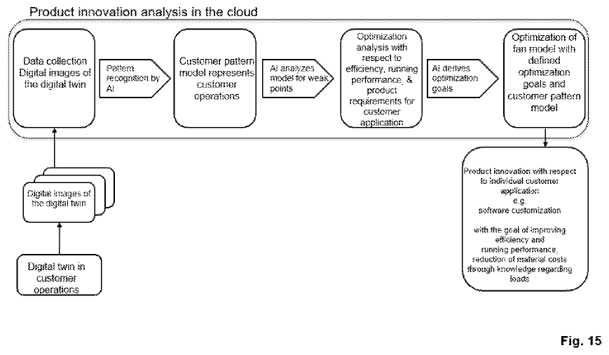

FIG. 15 shows a workflow that takes place autonomously in the/a cloud.

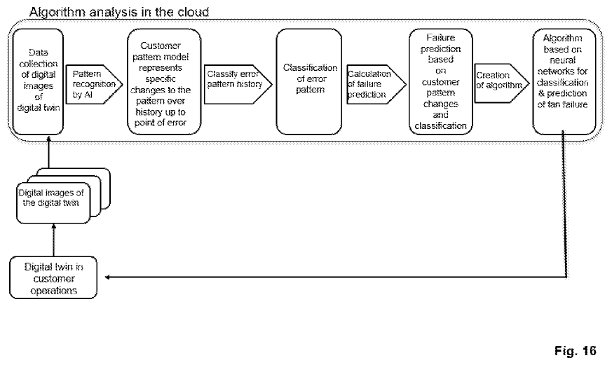

FIG. 16 relates to algorithm analysis in the cloud.

The goal of the intelligent algorithms is to improve and develop new algorithms for classifying and predicting a fan failure. Digital images of actual customer operations are collected. Artificial intelligence creates a pattern from the collected data and recognizes specific changes in the pattern over history up to the point of a malfunction. Based on the changes in the patterns, a malfunction can be classified and a prediction of failure can be made. This is converted into an algorithm, usually based on neural networks or self-learning systems. When an algorithm is improved or a new algorithm is created, the algorithm is transferred to the customer's operations, with improvement taking place cyclically or periodically. The workflow takes place automatically in the cloud as depicted in FIG. 16.

Finally, it should be expressly noted that the exemplary embodiments described above are intended only for the purpose of illustrating the claimed teaching, which is not restricted to these exemplary embodiments.

1. A method of optimizing operation of a fan or a fan arrangement, the method comprising:
generating a digital replica of the fan or of the fan arrangement as a representation of properties of the fan or fan arrangement, the representation based on one or more mathematical calculation models;
generating at least one operating parameter-specific algorithm, based on at least one of known relationships and characteristic curves;
generating a system behavior algorithm that calculates operating parameters of the fan or fan arrangement based on the digital replica and the at least one operating parameter-specific algorithm;
determining, by the system behavior algorithm, optimized control variables for the fan or fan arrangement during operation of the fan or fan arrangement; and
providing the determined optimized control variables to a machine learning algorithm; and
generating product innovations to the fan or fan arrangement and/or improved control algorithms based on information determined by the machine learning algorithm.

2. The method according to claim 1, further comprising:
generating detailed numerical models that describe component-specific or function-specific characteristics of the fan;
performing a model/data reduction on the detailed numerical models to thereby generate component-specific or function-specific reduced behavior models;
generating the system behavior model having input and output variables by coupling and/or combining reduced data of the reduced behavior models; and
performing an optimization algorithm based on the input and output variables of the system behavior model to thereby determine optimized control variables of the fan or a fan arrangement.

3. The method according to claim 1, wherein information determined by the machine learning algorithm.

4-5. (canceled)

6. provides information characterizing needs of an operator of the fan or fan arrangement.

7. The method of claim 1, wherein the machine learning algorithm provides information used for product innovations with respect to fans tailored individually to a customer.

8. The method of claim 1, wherein the machine learning algorithm generates improved algorithms for one or more of: optimizing calculation of service life of the fan or fan arrangement, optimizing operation of the fan or fan arrangement, and forecasting recommended maintenance of the fan or fan arrangement.

9. The method of claim 1, further comprising:
calculating component states of the fan or fan arrangement via the digital replica while the fan or fan arrangement is operating; and
providing the determined component states to the machine learning algorithm,
wherein the determined component states are provided to the machine learning algorithm optionally via a cloud based computing infrastructure.

10. The method of claim 1, wherein the machine learning algorithm is configured to generate artificial knowledge from the determined optimized control variables during operation of the fan or fan arrangement.

11. The method of claim 1, wherein the machine learning algorithm determines patterns and regularities based on states determined by the system behavior algorithm.
